(19) United States
(12) Patent Application Publication
(10) Pub. No.: US 2025/0138300 A1
(43) Pub. Date: May 1, 2025

(54) DIFFUSION MODULE

(71) Applicant: Qisda Corporation, Taoyuan City (TW)

(72) Inventors: Kuo-Chun Lee, Taoyuan City (TW); Chien-Chiang Hsu, Taoyuan City (TW)

(73) Assignee: Qisda Corporation, Taoyuan City (TW)

(21) Appl. No.: 18/916,731

(22) Filed: Oct. 16, 2024

(30) Foreign Application Priority Data
Oct. 30, 2023 (CN) 202311425698.7

(51) Int. Cl. G02B 26/00; G02B 5/02; G02B 26/02

(52) U.S. Cl. CPC G02B 26/007; G02B 5/0273; G02B 26/02

(57) ABSTRACT

A diffusion module including a motor, a washer, and a light diffusive material is provided. The motor has a rotation plate. The rotation plate is adapted to rotate around a central axis of the motor. The light diffusive material is sandwiched between the washer and the rotation plate.

### CROSS-REFERENCE TO RELATED APPLICATION

This application claims the priority benefit of China application serial no. 202311425698.7, filed on Oct. 30, 2023. The entirety of the above-mentioned patent application is hereby incorporated by reference herein and made a part of this specification.

### BACKGROUND

### Technical Field

The disclosure relates to an optical module, and more particularly, to a diffusion module.

### Description of Related Art

With the advancement of display technology and increasing needs of users, a projection device is also developing towards high brightness. If the brightness of the projection device is insufficient, an image provided by the projection device is easily interfered by ambient light. For example, all indoor lights are required to be turned off to clearly view the image provided by the projection device. In comparison, the projection device with high brightness has less trouble in this regard, which may still allow the users to clearly view the image provided by the projection device even when there is a little ambient light in the room.

In order to enable the projection device to have high brightness, one method is to use a laser light source as an illumination light source. However, due to high coherence of the laser light source, speckle occurs in the image. In order to improve the speckle phenomenon, a diffuser may be used to scatter a laser light to reduce the coherence of the laser light.

The conventional diffuser is disposed on a disk, and the disk is disposed on a motor to be rotated by the motor. When the laser light passes through the rotating diffuser, the speckle phenomenon may be effectively improved. However, a size of the disk is relatively large, which takes up a lot of space inside the projection device, making it difficult for a size of the projection device to meet a trend and demand for miniaturization.

### SUMMARY

The disclosure provides a diffusion module, which has a smaller volume.

An embodiment of the disclosure provides a diffusion module, including a motor, a washer, and a light diffusive material. The motor has a rotation plate. The rotation plate is adapted to rotate around a central axis of the motor. The light diffusive material is sandwiched between the washer and the rotation plate.

An embodiment of the disclosure provides a diffusion module, including a motor and a light diffusive material. The motor has a rotation plate. The rotation plate is adapted to rotate around a central axis of the motor. The light diffusive material is attached to a surface of the rotation plate facing away from a body of the motor.

An embodiment of the disclosure provides a diffusion module, including a motor and a light diffusive material. The motor has a rotation plate. The rotation plate is adapted to rotate around a central axis of the motor. The light diffusive material is combined on a side surface of the rotation plate facing away from the central axis.

In the diffusion module according to the embodiment of the disclosure, since the light diffusive material is disposed on the rotation plate of the motor, instead of being disposed on the disk outside the motor as in the conventional technology, the diffusion module may have a smaller volume.

### BRIEF DESCRIPTION OF THE DRAWINGS

FIG. 1A is a schematic view of a light path of a projection device according to an embodiment of the disclosure.

FIG. 1B is a schematic front view of a motor, a light diffusive material, and a washer in FIG. 1A.

FIG. 2A is a schematic side view of a diffusion module according to another embodiment of the disclosure.

FIG. 2B is a schematic front view of a motor, a light diffusive material, and a washer in FIG. 2A.

FIG. 3 is a schematic side view of a diffusion module according to still another embodiment of the disclosure.

FIG. 4 is a schematic side view of a diffusion module according to yet another embodiment of the disclosure.

FIG. 5 is a schematic side view of a motor, a light diffusive material, and a washer according to another embodiment of the disclosure.

### DETAILED DESCRIPTION OF DISCLOSED EMBODIMENTS

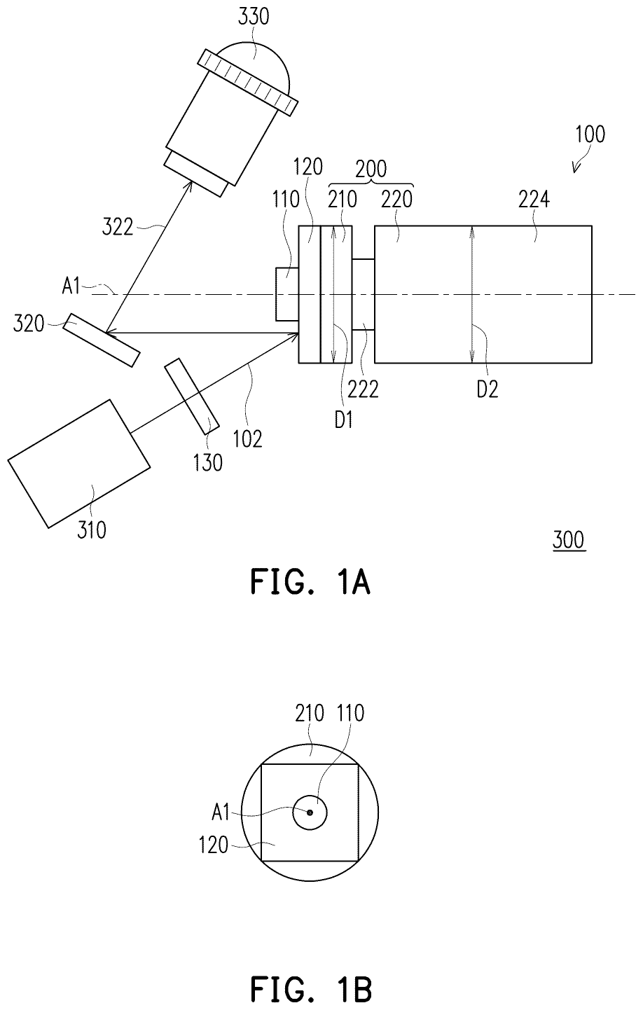

FIG. 1A is a schematic view of a light path of a projection device according to an embodiment of the disclosure. FIG. 1B is a schematic front view of a motor, a light diffusive material, and a washer in FIG. 1A. referring to FIGS. 1A and 1B, a projection device 300 in this embodiment includes a laser module 310, a diffusion module 100, a light valve 320, and a projection lens 330. The laser module 310 is configured to emit a beam 102, and the beam 102 is, for example, a laser beam. The laser module 310 may have a laser light source of a single color or multiple laser light sources of different colors, and the beam 102 is a laser beam of a single color, or is formed by multiple laser beams of different colors mixed together. In addition, the laser light sources of different colors in the laser module 310 may sequentially emit the laser beams of different colors, and the beam 102 refers to the laser beams of different colors at different times.

The diffusion module 100 includes a motor 200, a washer 110, and a light diffusive material 120. The motor 200 has a rotation plate 210. The rotation plate 210 is adapted to rotate around a central axis A1 of the motor 200. The rotation plate 210 may be integrally formed with a rotor 222 of the motor 200, or the rotation plate 210 may be fixed on the rotor 222 of the motor 200 in various ways. For example, the rotation plate 210 may be attached, welded, or locked to the rotor 222 of the motor 200. The light diffusive material 120 is sandwiched between the washer 110 and the rotation plate 210.

In this embodiment, the light diffusive material 120 is in direct contact with the rotation

plate 210, and the light diffusive material 120 is, for example, a diffusion-reflection diffusive material. In addition, in this embodiment, the washer 110 is locked on the rotation plate 210 to sandwich the light diffusive material 120. For example, the washer 110 may be locked on the rotation plate 210 through a screw, a bolt, or a clamping component.

In this embodiment, the diffusion module 100 further includes a haze sheet 130 disposed in front of the light diffusive material 120. The beam 102 penetrates the haze sheet 130 and then is transmitted to the light diffusive material 120.

In this embodiment, the beam 102 (i.e., the laser beam) emitted by the laser module 310 is diffused by the haze sheet 130 and the light diffusive material 120 sequentially, and then is transmitted to the light valve 320. The light valve 320 is configured to convert the beam 102 into an image beam 322. The projection lens 330 is disposed on a transmission path of the image beam 322 to project the image beam 322 to an external screen or projection plane, so that an image may be formed on the screen or projection plane to achieve a projection effect. After the beam 102 (i.e., the laser beam) is diffused by the haze sheet 130 and the light diffusive material 120, coherence thereof may be reduced, thereby suppressing a speckle phenomenon in the image. In particular, the light diffusive material 120 may be rotated by the motor 200 to move relative to the beam 102. Therefore, the coherence of the beam 102 may be further reduced, thereby better suppressing the speckle phenomenon in the image.

In the diffusion module 100 of this embodiment, the light diffusive material 120 is disposed on the rotation plate 210 of the motor 200, instead of being disposed on a disk outside the motor as in the conventional technology. Therefore, the diffusion module 100 may have a smaller volume, thereby complying with a trend toward miniaturization of the projection device 300. In this embodiment, an outer diameter D1 of the rotation plate 210 is less than or equal to an outer diameter D2 of a body 220 of the motor 200. That is to say, the light diffusive material 120 is disposed on the rotation plate 210 with a small size, instead of being disposed on a large disk, thus ensuring that the diffusion module 100 has a small size. In addition, a radius of the rotation plate 210 (i.e., a moving part) is reduced, which may effectively reduce vibration during rotation.

In this embodiment, the light diffusive material 120 is square when viewed along the central axis A1, as shown in FIG. 1B. The light diffusive material 120 may be cut into the square shape, which is easy to apply and facilitates a cutting process, and may reduce waste of the light diffusive material 120. However, in other embodiments, the light diffusive material 120 may be also circular or in other shapes when viewed along the central axis A1.

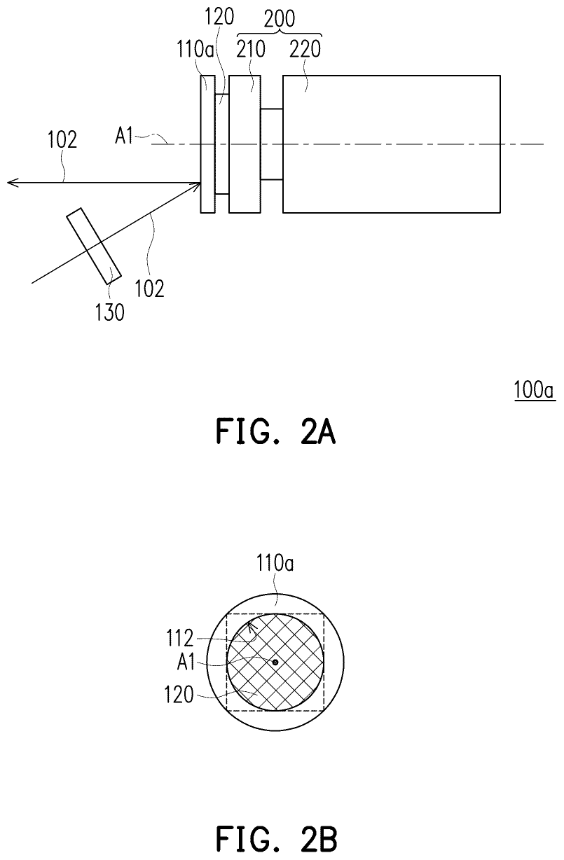

FIG. 2A is a schematic side view of a diffusion module according to another embodiment

of the disclosure. FIG. 2B is a schematic front view of a motor, a light diffusive material, and a washer in FIG. 2A. Referring to FIGS. 2A and 2B, a diffusion module 100a in this embodiment is similar to the diffusion module 100 in FIG. 1A, and main differences between the two are as follows. In the diffusion module 100a of this embodiment, a washer 110a is annular and has an opening 112. The opening 112 exposes the light diffusive material 120. In addition, in this embodiment, the light diffusive material 120 is square when viewed along the central axis A1 (a dashed box in FIG. 2B represents an edge of the light diffusive material 120, which is blocked by the washer 110a). The opening 112 is circular when viewed along the central axis A1, and the opening 112 exposes a circular area of the light diffusive material 120, as shown in FIG. 2B.

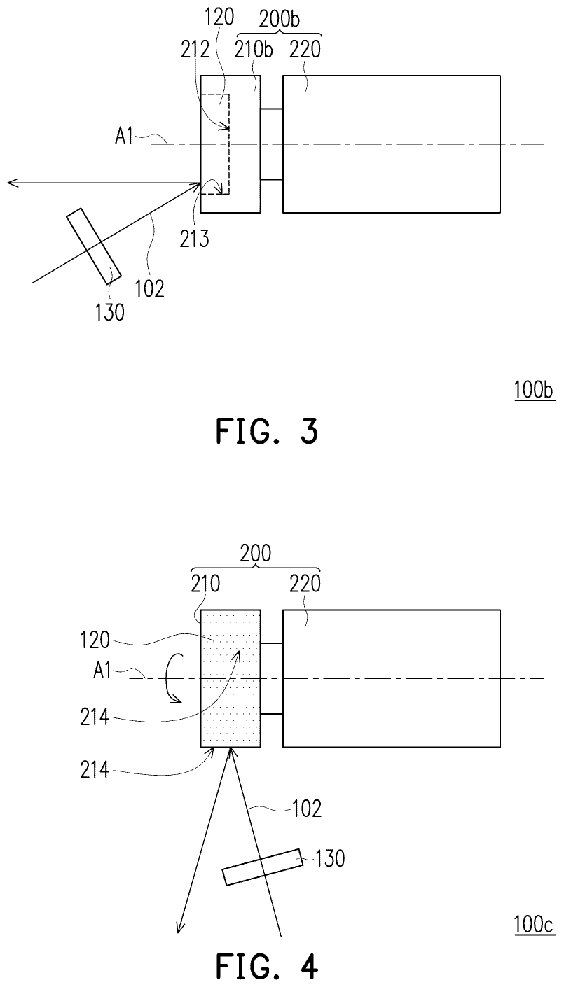

FIG. 3 is a schematic side view of a diffusion module according to still another embodiment of the disclosure. Referring to FIG. 3, a diffusion module 100b in this embodiment is similar to the diffusion module 100 in FIG. 1A, and main differences between the two are as follows. In the diffusion module 100b of this embodiment, the light diffusive material 120 is attached to a surface 212 of a rotation plate 210b facing away from the body 220 of a motor 200b. In this embodiment, the light diffusive material 120 is directly attached to the rotation plate 210b. In addition, in this embodiment, the surface 212 of the rotation plate 210b facing away from the body 220 has a recess 213, and the light diffusive material 120 is disposed in the recess 213.

FIG. 4 is a schematic side view of a diffusion module according to yet another embodiment of the disclosure. Referring to FIG. 4, a diffusion module 100c in this embodiment is similar to the diffusion module 100 in FIG. 1A, and main differences between the two are as follows. In the diffusion module 100c of this embodiment, the light diffusive material 120 is combined on a side surface 214 of the rotation plate 210 facing away from the central axis A1. In this embodiment, the light diffusive material 120 is directly attached to the side surface 214 of the rotation plate 210.

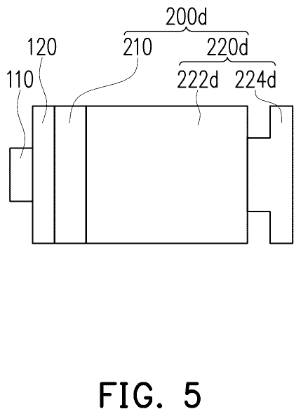

FIG. 5 is a schematic side view of a motor, a light diffusive material, and a washer according to another embodiment of the disclosure. Referring to FIG. 5, a motor 200d in this embodiment is similar to the motor 200 in FIG. 1A, and main differences between the two are as follows. In FIG. 1A, the rotor 222 of the motor 200 is embedded in a stator 224, while in the embodiment of FIG. 5, a stator 224d of a body 220d of the motor 200d is embedded in a rotor 222d. However, FIG. 1A is the same as FIG. 5 in that the rotation plate 210 may be integrally formed with the rotors 222 and 222d, or the rotation plate 210 may be fixed on the rotors 222 and 222d in various ways. For example, the rotation plate 210 may be attached, welded, or locked to the rotors 222 and 222d.

Based on the above, in the diffusion module according to the embodiment of the disclosure, since the light diffusive material is disposed on the rotation plate of the motor, instead of being disposed on the disk outside the motor as in the conventional technology. the diffusion module may have a smaller volume.

What is claimed is:

1. A diffusion module, comprising:
a motor having a rotation plate, wherein the rotation plate is adapted to rotate around a central axis of the motor;
a washer; and
a light diffusive material sandwiched between the washer and the rotation plate.

2. The diffusion module according to claim 1, wherein an outer diameter of the rotation plate is less than or equal to an outer diameter of a body of the motor.

3. The diffusion module according to claim 1, wherein the light diffusive material is in direct contact with the rotation plate.

4. The diffusion module according to claim 1, wherein the light diffusive material is square when viewed along the central axis.

5. The diffusion module according to claim 1, wherein the washer is locked on the rotation plate to sandwich the light diffusive material.

6. The diffusion module according to claim 1, further comprising a haze sheet disposed in front of the light diffusive material, wherein a beam penetrates the haze sheet and then is transmitted to the light diffusive material.

7. The diffusion module according to claim 6, wherein the light diffusive material is a diffusion-reflection diffusive material.

8. The diffusion module according to claim 1, wherein the washer is annular and has an opening, wherein the opening exposes the light diffusive material.

9. The diffusion module according to claim 8, wherein the light diffusive material is square when viewed along the central axis, the opening is circular when viewed along the central axis, and the opening exposes a circular area of the light diffusive material.

10. A diffusion module, comprising:
a motor having a rotation plate, wherein the rotation plate is adapted to rotate around a central axis of the motor; and
a light diffusive material attached to a surface of the rotation plate facing away from a body of the motor.

11. The diffusion module according to claim 10, wherein an outer diameter of the rotation plate is less than or equal to an outer diameter of the body of the motor.

12. The diffusion module according to claim 10, wherein the light diffusive material is directly attached to the rotation plate.

13. The diffusion module according to claim 10, wherein the surface of the rotation plate facing away from the body has a recess, and the light diffusive material is disposed in the recess.

14. The diffusion module according to claim 10, further comprising a haze sheet disposed in front of the light diffusive material, wherein a beam penetrates the haze sheet and then is transmitted to the light diffusive material.

15. The diffusion module according to claim 14, wherein the light diffusive material is a diffusion-reflection diffusive material.

16. A diffusion module, comprising:
a motor having a rotation plate, wherein the rotation plate is adapted to rotate around a central axis of the motor; and
a light diffusive material combined on a side surface of the rotation plate facing away from the central axis.

17. The diffusion module according to claim 16, wherein an outer diameter of the rotation plate is less than or equal to an outer diameter of a body of the motor.

18. The diffusion module according to claim 16, wherein the light diffusive material is directly attached to the side surface of the rotation plate.

19. The diffusion module according to claim 16, further comprising a haze sheet disposed in front of the light diffusive material, wherein a beam penetrates the haze sheet and then is transmitted to the light diffusive material.

20. The diffusion module according to claim 19, wherein the light diffusive material is a diffusion-reflection diffusive material.
